(19) United States
(12) Patent Application Publication
(10) Pub. No.: US 2007/0259201 A1
(43) Pub. Date: Nov. 8, 2007

(54) Reel Driving Device Comprising Driving Rolls Provided with a Cast Envelope

(76) Inventors: Thomas Holzhauer, Kirchhundem (DE); Karl-Friedrich Muller, Erndtebruck (DE); Uwe Raschke, Dillenburg (DE); Armin Sassmannshausen, Kirkhhundem (DE); Ludwig Hellenthal, Kirchhundem (DE); Wolfgang Kronert, Siegen (DE); Werner Otte, Wiesentheid (DE)

Correspondence Address: FRIEDRICH KUEFFNER, 317 MADISON AVENUE, SUITE 910, NEW YORK, NY, 10017, US

(21) Appl. No.: 10/581,479

(22) PCT Filed: Oct. 27, 2004
(86) PCT No.: PCT/EP04/12129

§ 371 Date: Apr. 2, 2007

(30) Foreign Application Priority Data
Dec. 1, 2003 (DE) 10356623.6
Mar. 30, 2004 (DE) 102004016204.2

(51) Int. Cl. B32B 15/18

(52) U.S. Cl. 428/615

(57) ABSTRACT

The invention relates to a reel driving device for rolling mills, said device comprising an upper driving roll (1′) and a lower driving roll (1). The aim of the invention is to improve said reel driving device in such a way that the rolled product is not damaged by the rolls (1, 1), that the rolled product does not adhere to the rolls (1, 1′), and that the driving rolls (1, 1) can be economically created as standard expendable parts. To this end, the lower driving roll (1) comprises a steel roll axle (2) to which a cast envelope (3) adheres and/or onto which said cast envelope is shrunk and/or the upper driving roll (1′) comprises a cast envelope (3′) held between two clamping elements (5) arranged on an axle (2′).

The invention concerns a reel driver for rolling mills with an upper and a lower driving roll.

Reel drivers of this type are used in hot rolling mills and cold rolling mills. The lower driving roll consists of solid material, e.g., steel with a wear-resistant layer formed by buildup welding, while the upper driving roll is a hollow roll made of steel with a wear-resistant layer formed by buildup welding.

However, disadvantages associated with this have been found to be that the rolls have pores on the surface of the roll jacket, which can produce roll marks in the rolled product, that the useful thickness of the wear layer on the rolls is relatively small, that the rolled strip often adheres to the rolls, and that the production of the buildup-welded roll bodies is very expensive.

The objective of the invention is to make available a reel driver that avoids these disadvantages.

To achieve this objective, the lower driving roll has a steel roll shaft on which a cast jacket is mounted by adhesive bonding and/or shrink fitting.

However, the objective can also be achieved by providing the upper driving roll with a cast jacket that is held between two clamping elements arranged on a shaft.

As a result of the use of cast jackets, the rolls have no pores in their surfaces that are in contact with the rolling stock, so that the surface of the rolling stock is not damaged when it makes contact with the driving rolls. In addition, the strip has a lesser tendency to adhere or remain stuck to the roll jacket.

It is advantageous for the cast jacket to have a working layer on the outside. This working layer can be inexpensively produced in sufficient thickness by centrifugal casting, so that the rolls have a zone of greater thickness available for grinding and a longer service life.

If the cast jacket is made of ductile iron, and the working layer is made of indefinite chill cast iron, an inexpensive jacket is obtained, which is very hard due to the indefinite chill cast iron and thus has a considerably longer service life.

If the working layer is made of chromium alloy cast iron or even of high-speed steel, even greater hardness and a longer service are obtained than with indefinite chill cast iron.

The invention is described in greater detail below with reference to the drawings.

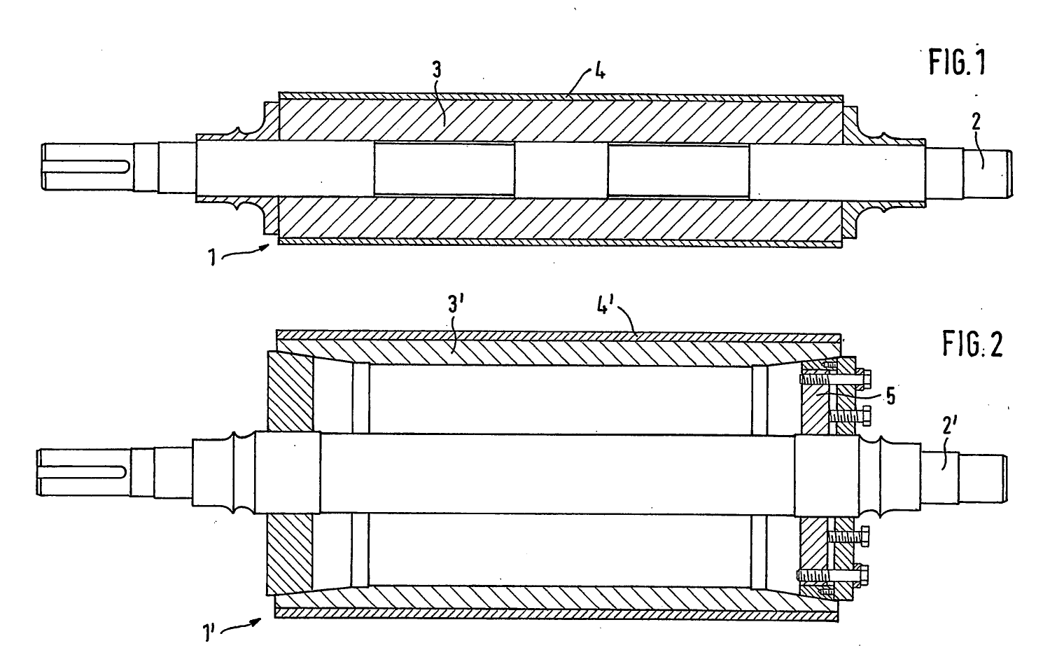

FIG. 1 shows a cross section through a lower driving roll.

FIG. 2 shows a cross section through an upper driving roll.

FIG. 1 shows a lower driving roll 1, which has a roll shaft 2 made of steel, on which a cast jacket 3 is mounted by adhesive bonding and/or shrink fitting. The cast jacket 3 is produced by the centrifugal casting process. Its outer periphery has a wear-resistant working layer 4.

FIG. 2 shows an upper driving roll 1′ with a roll shaft 2′. A cast jacket 3′ is clamped on the roll shaft 2′ by two clamping elements 5. The outer layer of the cast jacket 3′ consists of a wear-resistant working layer 4′ produced by centrifugal casting.

### LIST OF REFERENCE NUMBERS

1 lower driving roll
1′ upper driving roll
2 roll shaft
3 cast jacket
4 working layer
5 clamping elements

1. Reel driver for rolling mills with an upper and a lower driving roll, wherein the lower driving roll (1) has a steel roll shaft (2) on which a cast jacket (3) is mounted by adhesive bonding and/or shrink fitting, and that the upper driving roll (1′) has a cast jacket (3′) that is held between two clamping elements (5) arranged on a shaft (2′).

2. Reel driver in accordance with claim 1, wherein the cast jacket (3, 3′) consists of ductile iron and has an outer working layer (4, 4′) produced by the centrifugal casting process.

3. Reel driver in accordance with claim 2, wherein the ductile iron consists of 2.5-4.0 vol. % C, 1.0-4.0 vol. % Si, 0.2-2.0 vol. % Mn, <0.10 vol. % P, <0.05 vol. % S, <1.0 vol. % Cr, <5.0 vol. % Ni, <3.0 vol. % Mo, <1.0 vol. % Al, and <5.0 vol. % Cu.

4. Reel driver in accordance with claim 1, wherein the working layer (4, 4′) consists of indefinite chill cast iron.

5. Reel driver in accordance with claim 4, wherein the indefinite chill cast iron consists of 2.7-3.8 vol. % C, 0.5-2.0 vol. % Si, 0.3-1.5 vol. % Mn, <0.15 vol. % P, <0.10 vol. % S, 1.0-3.5 vol. % Cr, 1.0-5.0 vol. % Ni, 0.1-0.8 vol. % Mo, 0.010-0.5 vol. % Al, and 0.5-5.0 vol. % Cu.

6. Reel driver in accordance with claim 2, wherein the working layer (4, 4′) consists of indefinite chill cast iron with alloy carbides.

7. Reel driver in accordance with claim 6, wherein the indefinite chill cast iron with alloy carbides consists of 2.7-3.8 vol. % C, 0.5-2.0 vol. % Si, 0.3-1.5 vol. % Mn, <0.15 vol. % P, <0.10 vol. % S, 1.0-3.5 vol. % Cr, 1.0-5.0 vol. % Ni, 0.1-0.8 vol. % Mo, 0.010-0.5 vol. % Al, 0.5-5.0 vol. % Cu, 0.5-4.0 vol. % V, 0.5-5.0 vol. % Nb, and 0.5-5.0 vol. % Ta.

8. Reel driver in accordance with claim 2, wherein the working layer (4, 4′) consists of chromium alloy cast iron.

9. Reel driver in accordance with claim 8, wherein the chromium alloy cast iron consists of 0.8-3.5 vol. % C, 0.5-2.0 vol. % Si, 0.4-3.0 vol. % Mn, <0.15 vol. % P, <0.10 vol. % S, 8-35 vol. % Cr, 0.5-4.0 vol. % Ni, 0.1-5 vol. % Mo, 0.5-5.0 vol. % Cu, 0.5-4.0 vol. % V, 0.5-5.0 vol. % Nb, and 0.5-5.0 vol. % Ta.

10. Reel driver in accordance with claim 2, wherein the working layer (4, 4′) consists of high-speed steel (HSS).

11. Reel driver in accordance with claim 10, wherein the high-speed steel consists of 0.5-3.0 vol. % C, 0.5-2.0 vol. % Si, 0.4-3.0 vol. % Mn, <0.15 vol. % P, <0.10 vol. % S, 2-10 vol. % Cr, 0.5-4.0 vol. % Ni, 2-10 vol. % Mo, 0.5-5.0 vol. % Cu, 2-10 vol. % V, and 1-15 vol. % W.
